(19) United States
(12) Patent Application Publication
(10) Pub. No.: US 2004/0002239 A1
(43) Pub. Date: Jan. 1, 2004

(54) Mechanism for electrically connecting an electronic device to a garment

(76) Inventors: George Marmaropoulos, Yorktown Heights, NY (US); Clive R. Van Heerden, Bronx, NY (US); Jack Mama, London (GB); Jeremy Wright, Langho (GB); Giang Truong Vu, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/185,882

(22) Filed: Jun. 28, 2002

(51) Int. Cl. H01R 25/00

(52) U.S. Cl. 439/110

(57) ABSTRACT

A mechanism for electrically connecting various electronic devices to a garment is provided. The mechanism has a sliding track adapted to support a variety of different electronic devices. The sliding track has one or more channels enabling elective electrical communication between at least one electronic device and a power source. The electronic device is adapted to be selectively supported by the sliding track such that the electronic device can slide along the sliding track. The mechanism has one or more channels having at least one conductive element disposed therein. The first conductive element is shaped to conform to one or more channels to provide an ideal electrical contact surface. The one or more channels are adapted to selectively enclose or seal the conductive element.

### FIELD OF THE INVENTION

The present invention relates to a mechanism for use in an article of clothing, wearable fabric or garment. More particularly, the present invention relates to a mechanism adapted to enable a user to electrically connect different electrically powered devices to a wearable fabric or garment.

### BACKGROUND OF THE INVENTION

Efforts have been made previously to create clothes, fabrics and garments that incorporate electrodes for monitoring a condition of the wearer, such as an Electro-cardiogram, or conductive fibers for electromagnetic screening. U.S. Pat. No. 4,580,572 to Granek et al. discloses a garment for delivering and receiving electric impulses which can include wires sewn onto the cloth or conducting cloth sewn onto non-conducting cloth.

However, although useful, these patents fail to address and combat the inherent problems of utilizing wearable electronics. There exist certain operational problems in wearable electronics. These operational problems include the interface between soft fabrics and hard product. This interface, for instance between a shirt and bulky computer or bulky sensory equipment can lead to uncomfortable results to the wearer of the article of clothing. Attaching a bulky product to the inside of a jacket or shirt can cause discomfort, cuts, burns, bruises and related injury to the wearer. Furthermore, there also exist problems associated with the decreased flexibility of the article of clothing that has a bulky hard product disposed therein. Generally, the comfort, flexibility and fit of an article decrease dramatically when a user adds bulky, heavy and inflexible electronic devices to the garment.

Additionally, there also are operational difficulties with regard to electrical connectivity between the electronic device and a circuit integrated in the article of clothing. Given the wide range of activities that the wearer may engage in, either rain or perspiration may penetrate or otherwise enter the electrical circuit. Fluid, perspiration and moisture may disrupt the operation of the wearable garment hence, the difficulties associated with the implementation in practice. Additionally, protection of the wearer of the garment from the detrimental attributes of an electronic device is a great concern.

A need, therefore, exists for a mechanism for electrically connecting various electronic devices to an article of clothing. There is also a need for an improved mechanism having a sliding track for carrying the various electronic devices, the sliding track having at least one channel, the channel selectively enclosing at least one conductive element disposed therein, the channel enabling selective access to the at least one conductive element. Further, there is a need for an improved mechanism having a sliding track for carrying the various electronic devices attached to an article of clothing that is comfortable, and flexible. Still further, there is also a need for an improved mechanism for electrically connecting an electronic device to a power supply that will not permit perspiration, fluid or moisture to interrupt the electrical connection and that is safe and not maintenance intensive.

### SUMMARY OF THE INVENTION

There is provided a mechanism for electrically connecting various electronic devices to a garment. The mechanism has a sliding track for engaging and slidably supporting at least one electronic device. The sliding track has one or more channels with at least one conductive element disposed therein. The one or more channels selectively enclose or seal the one or more conductive elements so as to allow for the selective electrical communication between the at least one electronic device and a power source.

### BRIEF DESCRIPTION OF THE DRAWINGS

Other objects, advantages and features of the present invention will be understood by reference to the following specification in conjunction with the accompanying drawings, in which like reference characters denote like elements of structure and:

FIG. 1 is a cross sectional view of the mechanism for electrically connecting various electronic devices to an article of clothing of the present invention with the conductors in the open position;

FIG. 2 is a cross sectional view of the mechanism for electrically connecting various electronic devices to an article of clothing of the present invention with the conductors in the closed position;

FIG. 3 is a top view of the mechanism for electrically connecting various electronic devices to an article of clothing;

FIG. 4 is a side view of the mechanism for electrically connecting various electronic devices to an article of clothing;

FIG. 5 is a cross sectional view of another exemplary embodiment of the mechanism for electrically connecting various electronic devices to an article of clothing;

FIG. 6 is a top view of the mechanism of FIG. 5;

FIG. 7 is a cross sectional view of the mechanism along line A-A of FIG. 5.

### DESCRIPTION OF THE PREFERRED EMBODIMENT

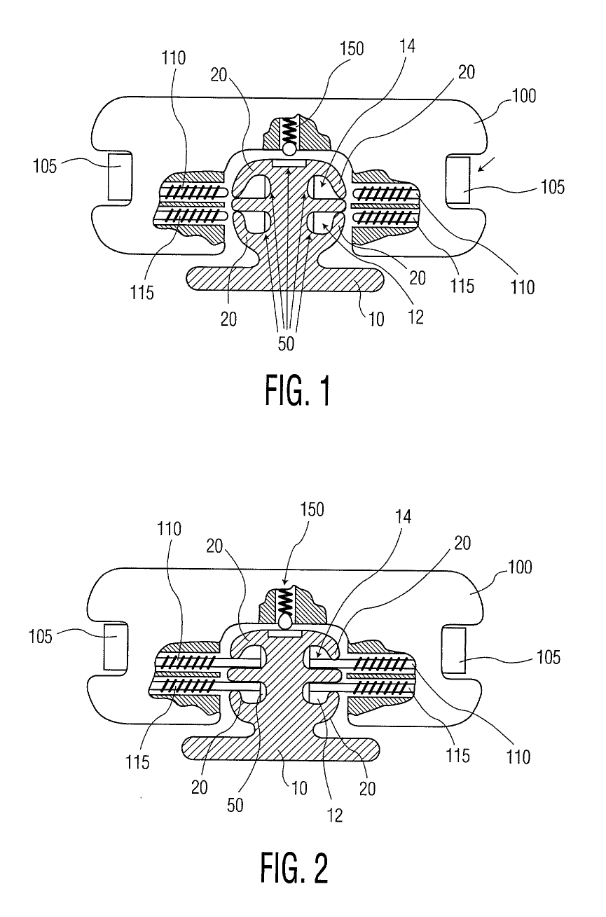

With reference to FIGS. 1 through 7, there is provided a mechanism for electrically connecting various electronic devices to an article of clothing. The mechanism includes a sliding track 10 for carrying various electronic devices, such as for example diagnostic equipment, sensors, mobile computers, cooling devices and mobile telephones. Sliding track 10 is a bulbous member. Sliding track 10 may be stitched, knit, bonded, adhered or affixed via a hook and loop material to an article of clothing. Sliding track 10 has a flat bottom surface that may be disposed adjacent to or attached to a garment. Sliding track 10 may be extruded from a suitable non-conductive material and may be cut or stitched to a garment, such as a shirt, pants, shoes, hat or coat. In an exemplary embodiment of the present invention, sliding track 10 is formed from rubber. The sliding track 10 has a top surface that is disposed on the exterior surface of an exemplary garment. The top or bulbous area of the sliding track 10 has a plurality of channels. In an exemplary embodiment of the present invention, the sliding track 10 may have two lower channels 12 and two upper channels 14. Lower channels 12 and upper channels 14 may be formed as U shaped apertures cut out or extruded with the sliding track 10.

In an exemplary embodiment of the present invention, the upper channels 14 and lower channels 12 have curvilinear edges 20 that define slits in the lateral sides of the sliding track 10. An exemplary feature of the upper channels 14 and the lower channels 12 is that the upper channels 14 and the lower channels 12 encapsulate or otherwise seal and/or insulate at least one first conductive material, such as a copper wire, a metal coated carbon fiber, a metallic fiber, a doped fiber, a conductive fiber, an conductive organic material or a conductive polymer that may be disposed therein. In this manner, the upper channels 14 and the lower channels 12 prevent moisture, perspiration or fluid from entering upper channels 14 and lower channels 12.

Disposed in the respective upper channels 14 and lower channels 12 is at least one first conductive material forming a lengthwise strip of material 50. An exemplary feature of the first conductive material 50, is that first conductive material 50 is disposed along a length of the sliding track 10 in each respective channel. First conductive material 50 may be stitched into the sliding track 10. In another exemplary aspect, the first conductive material 50 may be any suitable material that may conduct electricity or photons particles. First conductive material 50 may be disposed in any suitable location in upper channels 14 and the lower channels 12 so as to maintain the seal and/or insulation properties of the upper channels 14 and the lower channels 12. For illustrative purposes, the first conductive material 50 is disposed on the respective lateral side walls of the sliding track 10 parallel to the vertical center axis of the sliding track 10. Another exemplary feature of the first conductive material 50 is that the first conductive material 50 is electrically connected to a power source, for example a battery pack (not shown). Power source (not shown) may be a portable battery, a DC power source, solar power or any other suitable power supply for supplying electric current to the first conductive material 50.

In an exemplary embodiment of the present invention, first conductive material 50 is sewn or otherwise disposed in the garment. The first conductive material 50 is disposed in between the respective edges 20 of the U shaped channels in a manner to maintain a seal to prevent perspiration, moisture or any fluid from entering into and contacting the first conductive material 50 throughout the length of the garment. First conductive material 50 is also insulated to protect the wearer of the garment. An aspect of the exemplary insulation is that thermal and electrical conductivity, from the power supply (not shown) to the first conductive material 50 is not transmitted to the user's body tissues.

Referring now again to FIG. 1, there is shown an exemplary attachable portable electronic device 100 that may be affixed to an exemplary garment. Electronic device 100 is illustrated as a rectangular shaped device, however one skilled in the art should appreciate that electronic device 100 may be any suitable shape and size. An exemplary feature of the electronic device 100 is that electronic device 100 has a plurality of spring biased rectangular buttons 105 disposed on the lateral sides of the electronic device 100. Connected to buttons are a plurality of second conductive elements 110 and 115. Second conductive elements 110 and 115 are shown as rectangular cylindrical structures, however second conductive elements 110 and 115 may be any suitable shape and size to allow second conductive elements 110 and 115 to mate with the respective upper channels 14 and lower channels 12. An exemplary feature of the second conductive elements 110 and 115 is that second conductive elements 110 and 115 protrude through the respective edges 20, insulation and/or seal and interface or otherwise mate with at least one first conductive element 50 to provide electrical power to electronic device 100. One skilled in the art should appreciate that second conductive elements 110 and 115 are made from any suitable electrically conductive material, such as for example a copper wire, a metal, a conductive polymer, a metal coated carbon fiber, a doped fiber a metallic fiber, a wire, or any combination thereof. A plurality of spring members 120 are disposed along the length of the second conductive elements 110 and 115. However, any other suitable method for biasing second conductive elements 110 and 115 may be utilized and incorporated into the present invention.

Referring now to FIG. 2, as can be understood from the drawings there is shown the sliding track 10 with electronic device 100 receiving electrical power from the first conductive element 50. In an exemplary embodiment of the present invention, electronic device 100 has a contact 150 for a connection with ground. Contact 150 is disposed in the interior of electronic device 100, however it should be appreciated that contact 150 may be disposed in any suitable location in electronic device 100 for grounding electronic device 100. It should be appreciate by one skilled in the art that a user may depress buttons 105 by imparting an axial force to at least one or both buttons 105 on the exterior surface of electronic device 100. In this manner, second conductive elements 110 and 115 extend laterally in the direction toward sliding track 10. One skilled in the art should appreciate that the second conductive elements 110 and 115 protrude through the channel edges 20, insulation and/or seal and contact or otherwise communicate with the at least one first conductive element 50. In this manner, the power from mobile power supply (not shown) is directed through first conductive element 50 to the second conductive elements 110 and 115.

In an illustrative embodiment of the present invention, the second conductive elements 110 and 115 contact and supply electrical power to electronic device 100 to operate electronic device 100. In an exemplary embodiment of the present invention, the electronic device 100 may be any suitable product 100 that utilizes electric power such as a computing device, a semiconductor, a sensor for monitoring physical aspects of the wearer, a mobile telephone, a mobile information infrastructure or any other suitable portable electronic device that may be attached to a garment and add beneficial qualities to the wearer and user.

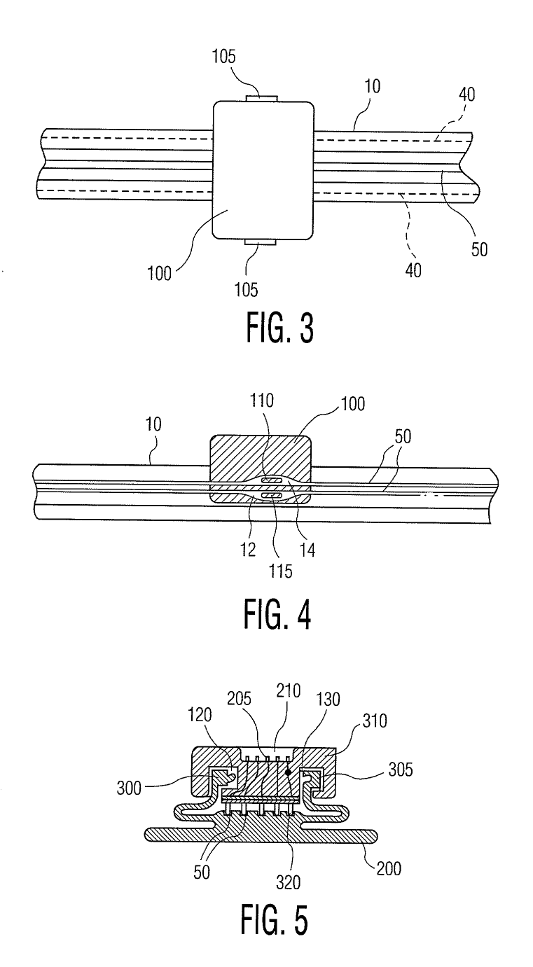

Referring to FIG. 3 and FIG. 4, there is provided a respective top view and a cross sectional side view of an exemplary embodiment of the present invention for illustration purposes only. As can be understood from the drawings slider track 10 is stitched to the garment by knit operation 40. However, any known methods in the art for attaching slider track 10 to a garment may be utilized including for example an adhesive, a hook and loop operation and/or bonding. As can be further understood from FIG. 3, the electronic device 100 has buttons 105 that extend and protrude outward from the exterior lateral sides of electronic device 100. It should also be appreciated that buttons 105 may be place in any suitable location disposed on electronic device 100 for allowing the second conductive elements 110 and 115 to mate with the respective pair of first channels 14 and second channels 12. Buttons 105 allow respective pair of second conductive elements 110 and 115 to interface with first conductive element 50 and transfer electrical power from first conductive element 50 to second conductive elements 110 and 115 to electronic device 100 for operational purposes.

It should be also appreciated by one skilled in the art, that electronic device 100 may slide, glide or otherwise traverse vertically up and down the face of the garment in substantially parallel relation to first conductive element 50, on sliding track 10 without a short circuit or interruption of power. An exemplary aspect of the sliding track 10 is that the sealing and/or insulation of the respective first channels 14 and respective second channels 12 is not disturbed by the sliding movement of the electronic device 100. Respective first channels 14 and respective second channels 12 are fabricated such that perspiration, fluid or moisture does not at any time enter the respective first channels 14 and respective second channels 12 to interrupt the transfer of power from first conductive material 50 to electronic device 100.

Referring to FIG. 5, there is provided a cross sectional view of another exemplary embodiment of the present invention. An adapter 310 or intermediate element is provided. Adapter 310 may be formed as a rectangular structure. Disposed on the bottom side of adapter 310 are a number of third conductive elements 320. A strip 200 may also include a first protective element 300 and a second protective element 305 disposed on the top side of the strip 200. An exemplary aspect of the first protective element 300 and the second protective element 305 is that the respective first protective element 300 and the second protective element 305 overlay and provide a seal and/or insulation to the first conductive element 50 disposed within the strip 200.

In an exemplary embodiment of the present invention, a number of third conductive elements 320 are disposed on the bottom side of an adapter 310. One skilled in the art should appreciate, that any number of third conductive elements 320 may be used to transmit a suitable amount of power through adapter 310 to an exemplary electronic device (not shown). Third conductive elements 320 interface with first conductive element 50 to provide power to an exemplary electronic device (not shown). First conductive element 50 may be disposed in any suitable location in a flexible strip 200. Strip 200 may be a rectangular shaped thermally non-conductive and electrically non-conductive structure that houses the first conductive element 50.

An exemplary feature of the first conductive element 50 is that the first conductive element 50 is in spaced relation and adjacent to a first protective element 300 and a second protective element 305. First protective element 300 and a second protective element 305 mate with one another to act as a seal and insulator. In this manner, the first protective element 300 and the second protective element 305 prevent moisture, perspiration and/or fluid from entering and interrupting the flow of power through the first conductive element 50 disposed in the strip 200. An exemplary feature of the first protective element 300 and a second protective element 305 is that the respective first protective element 300 and a second protective element 305 are a substantially rectangular in shape. The respective first protective element 300 and a second protective element 305 include a connection point having a male and female member disposed therebetween to allow the respective first protective element 300 and a second protective element 305 to interface with respect to one another. The respective first protective element 300 and a second protective element 305 are selectively attached to strip 200 that houses the first conductive element 50. The respective first protective element 300 and second protective element 305 extend outward from strip 200 and are of a suitable width to fit within a pair of arcuate channels 120, 130 that are disposed on adapter 310.

It should be appreciated by one skilled in the art, that strip 200 may be connected or otherwise stitched to the garment. A number of third conductive elements 320 are electrically connected through adapter 10 by wires to an exemplary socket or interface 205 disposed on the top surface of the adapter 10. Top surface of the adapter 10 includes an aperture 210 for allowing the respective plurality of second conductive elements (not shown) disposed on an exemplary electronic device to connect with socket 205 so electronic device may receive power when electronic device is disposed on top of adapter 310.

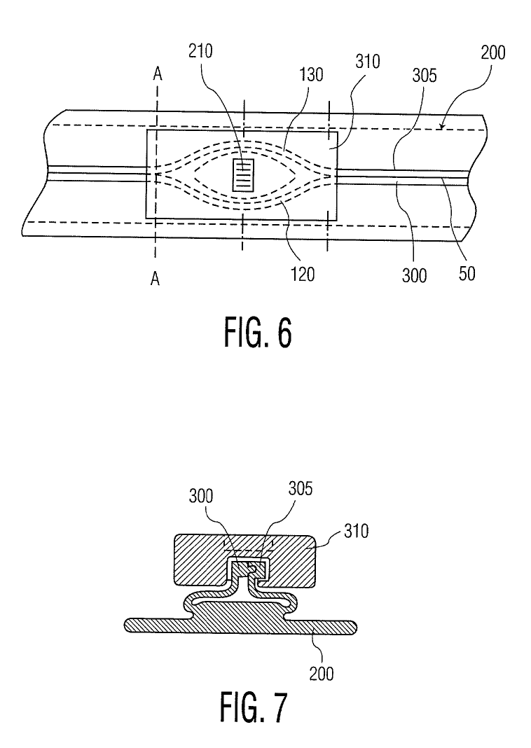

Referring to FIG. 6, there is provided a top view of the present invention. As can be understood from the drawings, the respective first channel 120 and the second channel 130 are curvilinear in shape. First channel 120 and second channel 130 allow first protective element 300 and a second protective element 305 to spread apart with respect to one another and pass therethrough. In this manner, an exemplary electronic device 100 may transverse strip 200 disposed on garment. As can be further understood from the drawings, an electronic device may be disposed on the socket 210 on the top surface of the adapter 310. Strip 200 is made from a suitable thermally and electrically non-conductive material. Strip 200 may be attached by a knit operation to an exemplary garment.

Referring to FIG. 7, there is provided a cross sectional view along line AA of the adapter 310. As can be understood from the drawings, the strip 200 has the respective first protective element 300 and second protective element 305 disposed on the top surface of strip 200. In this manner, first protective element 300 and second protective element 305 are spread apart. First protective element 300 and second protective element 305 pass through the respective first channel 120 and second channel 130 in the curvilinear fashion as adapter 310 traverses the strip 200. Along line A-A, the first channel 120 and second channel 130 intersect to form a sole unified channel. After adapter 310 passes over a portion of the strip 200 the curvilinear channels 120, 130 direct first protective element 300 to mate with second protective element 305 as shown in FIG. 7. The first protective element 300 mates with second protective element 305 as shown in FIG. 7, thereby allowing the strip 200 to seal and encapsulate the respective at least one first conductive element 50 disposed therein. One skilled in the art should appreciate first protective element 300 and second protective element 305 in the closed position as shown in FIG. 7 are suitable to prevent moisture, perspiration and fluid from entering therein so that uninterrupted power may be transferred from a power supply (not shown) to the exemplary electronic device 100.

The present invention having been thus described with particular reference to the preferred forms thereof, it will be obvious that various changes and modifications may be made therein without departing from the spirit and scope of the present invention as defined in the appended claims.

What is claimed is:

1. A mechanism for electrically connecting an electronic device to a garment, comprising:
a sliding track adapted to support at least one electronic device,
wherein said sliding track has one or more channels enabling selective electrical communication between said at least one electronic device and a power source.

2. The mechanism of claim 1, wherein said at least one electronic device is adapted to be selectively supported by said sliding track such that said electronic device can slide along said sliding track.

3. The mechanism of claim 2, wherein said one or more channels have at least one first conductive element disposed therein.

4. The mechanism of claim 3, wherein said at least one first conductive element is shaped to conform with said one or more channels to provide an ideal electrical contact surface.

5. The mechanism of claim 3, wherein said one or more channels are adapted to selectively enclose said at least one first conductive element.

6. The mechanism of claim 5, wherein said one or more channels are adapted to selectively seal said at least one first conductive element to prevent fluid from making contact therewith.

7. The mechanism of claim 5, wherein said at least one electronic device has at least one second conductive element for making selective electrical contact with said at least one first conductive element in said one or more channels.

8. The mechanism of claim 7, wherein said at least one second conductive element is adjustable to facilitate the selective electrical communication with said at least one first conductive element in said one or more channels.

9. The mechanism of claim 8, wherein said at least one second conductive element is adjustable to facilitate the selective securing of said at least one electronic device to said sliding track.

10. The mechanism of claim 9, wherein said at least one second conductive element is adjustable via an actuator.

11. The mechanism of claim 1, wherein said sliding track is permanently connected to said garment by at least one of the group consisting of (a) a knit operation, (b) a bonding operation, (c) a stitch operation, (d) an adhesive operation, (e) a mechanical operation, or (f) any combination thereof.

12. The mechanism of claim 3, further comprising an adapter for facilitating the selective electrical communication between said at least one electronic device and said at least one first conductive element.

13. The mechanism of claim 12, wherein said at least one electronic device has at least one second conductive element and wherein said adapter has at least one third conductive element adapted to selectively connect said at least one second conductive element with said at least one first conductive element in said one or more channels.

14. The mechanism of claim 13, wherein one or more channels have a first and a second protective element, wherein said first and second protective elements cooperate to maintain the sealed integrity of said one or more channels while simultaneously allowing for the selective electrical communication between said at least one third conductive element of said adapter and said at least one first conductive element of said one or more channels.

15. The mechanism of claim 14, wherein said first and said second protective elements are disposed between said one or more channels and said adapter, wherein said first and said second protective elements are shaped to conform with said sliding track such that said at least one first conductive element of said one or more channels is sealed to prevent fluid from making contact therewith.

16. The mechanism of claim 15, wherein said adapter selectively opens and closes said first and said second protective elements to allow said at least one third conductive elements to make electrical contact with said at least one first conductive element in said one or more channels.

17. The mechanism of claim 16, wherein said adapter can selectively slide along said sliding track such that the sealed integrity of said one or more channels is maintained while said at least one third conductive element is in electrical communication with said at least one first conductive element of said one or more channels.

18. A method for electrically connecting at least one electronic device to a garment, comprising the step of:
supporting said at least one electronic device on a sliding track, said sliding track having at least one channel and
enabling selective electrical communication between said at least one electronic device and a power source.

19. The method of claim 18, further comprising the step of selectively supporting said at least one electronic device on said sliding track wherein said at least one electronic device is adapted to slide on said sliding track.

20. The method of claim 19, further comprising the step of selectively enclosing a first conductive element within said at least one channel.

21. The method of claim 20, further comprising the step of selectively sealing said first conductive element within said at least one channel, said at least one channel adapted to prevent fluid from entering said at least one channel therein.

22. The method of claim 21, further comprising the step of contacting at least one second conductive element to said at least one first conductive element in said at least one channel, said at least one second conductive element disposed in said at least one electronic device.

23. The method of claim 22, further comprising the step of adjusting said at least one second conductive element for facilitating electrical communication between said at least one second conductive element and said at least one first conductive element, in response thereto.

24. The method of claim 21, further comprising the step of protecting said at least one channel by providing a first protective element and a second protective element, said first protective element and said second protective element cooperating to seal said channel, while simultaneously allowing for selective electrical communication between at least one third conductive element.

25. The method of claim 24, further comprising the step of electrically connecting said at least one third conductive element to said at least one first conductive element, said at least one third conductive element disposed on an adapter.

26. The method of claim 25, further comprising the step of fastening said electronic device to said adapter, such that a power source transfers electrical power through said at least one first conductive element, said at least one second conductive element and said at least one third conductive element to said at least one electronic device.
